(19) United States
(12) Patent Application Publication
(10) Pub. No.: US 2023/0343980 A1
(43) Pub. Date: Oct. 26, 2023

(54) METHODS AND SYSTEMS FOR OPERATING REDOX FLOW BATTERY

(71) Applicant: ESS TECH, INC., Wilsonville, OR (US)

(72) Inventors: Yang Song, West Linn, OR (US); Craig Evans, West Linn, OR (US); Brady Thompson, Canby, OR (US)

(21) Appl. No.: 18/179,262

(22) Filed: Mar. 6, 2023

Related U.S. Application Data
(60) Provisional application No. 63/363,612, filed on Apr. 26, 2022.

(51) Int. Cl. H01M 8/18; H01M 8/04537

(52) U.S. Cl. CPC H01M 8/188; H01M 8/04552

(57) ABSTRACT

Systems and methods are provided for a redox flow battery. In one example, a method of operating a redox flow battery includes charging the redox flow battery, including supplying a pulsed power signal to the redox flow battery in response to the redox flow battery state of charge (SOC) decreasing below a lower threshold redox flow battery SOC, wherein supplying the pulsed power signal includes supplying a pulse-width-modulated (PWM) charging voltage signal to the redox flow battery, the PWM charging voltage signal fluctuating between an upper threshold charging voltage and an open circuit voltage (OCV).

### CROSS REFERENCE TO RELATED APPLICATIONS

The present application claims priority to U.S. Provisional Application No. 63/363,612 entitled METHODS AND SYSTEMS FOR OPERATING REDOX FLOW BATTERY filed Apr. 26, 2022. The entire contents of the above identified application are hereby incorporated by reference for all purposes.

### FIELD

The present description relates generally to methods and systems for operating a redox flow battery.

### BACKGROUND AND SUMMARY

Redox flow batteries, such as all-iron redox flow batteries (IFBs), are advantageous as compared with Li-ion type batteries due to their low cost, long run time, low fire risk, and potential for long lifetime with unlimited cycling. However, due to the aqueous nature of the electrolytes, redox flow batteries may have lower power density and energy density relative to Li-ion batteries. Reducing IFB performance losses may aid in bridging the power and energy density gap relative to traditional batteries. IFB performance losses may be attributed largely to losses at the plating electrode, as well as losses at the redox electrode and ohmic resistance losses. Operating a redox flow battery at higher temperatures may aid in reducing ohmic resistance losses, but may incur higher material costs to ensure the robustness of system plumbing when operating at higher temperatures. Reducing the plating gap at the plating electrode may also aid in increasing redox flow battery efficiencies. However, retrofitting existing systems to accommodate the reduced plating gap may be complex and costly.

One approach that at least partially addresses the issues discussed above, includes a method of operating a redox flow battery, including charging the redox flow battery, including supplying a pulsed power signal to the redox flow battery in response to the redox flow battery state of charge (SOC) decreasing below a lower threshold redox flow battery SOC. Supplying the pulsed power signal includes supplying a pulse-width-modulated (PWM) charging voltage signal to the redox flow battery, the PWM charging voltage signal fluctuating between an upper threshold charging voltage and an open circuit voltage (OCV). In this way, the technical effect of increasing a voltaic efficiency and energy efficiency of the redox flow battery system may be achieved, while maintaining a coulombic efficiency of the redox flow battery system. Furthermore, the increases in voltaic efficiency and energy efficiency are attained while maintaining a redox flow system operating temperature, thereby lowering material costs and maintaining reliability and durability of the system plumbing. Further still, increases in voltaic efficiency and energy efficiency are attained while maintaining a plating gap at the plating electrode, thereby facilitating retrofitting of existing redox flow battery systems to achieve the gains in voltaic and energy efficiency without increasing manufacturing costs and complexity.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including a power module and electrolyte subsystem.

FIG. 2 shows a schematic diagram of an electric energy storage system of the power module of FIG. 1, including a plurality of stacks of redox flow battery cells.

FIGS. 3A and 3B show example plots of pulse-width-modulated (PWM) charging and discharging voltage signals.

FIG. 4 shows an example graph comparing positive electrode potential for continuous charging and pulse charging.

FIG. 5 shows an example graph comparing negative electrode potential for continuous charging and pulse charging.

FIG. 6A shows a graph of voltaic efficiency as a function of duty cycle.

FIG. 6B shows a graph of coulombic efficiency as function of duty cycle.

FIG. 6C shows a graph of energy efficiency as function of duty cycle.

FIG. 7A shows a graph relating plating efficiency to electrolyte pH.

FIG. 7B shows a graph relating state of charge (SOC) to open circuit voltage (OCV).

FIGS. 8-10 show example methods of operating a redox flow battery of FIGS. 1 and 2, including charging and discharging the redox flow battery.

### DETAILED DESCRIPTION

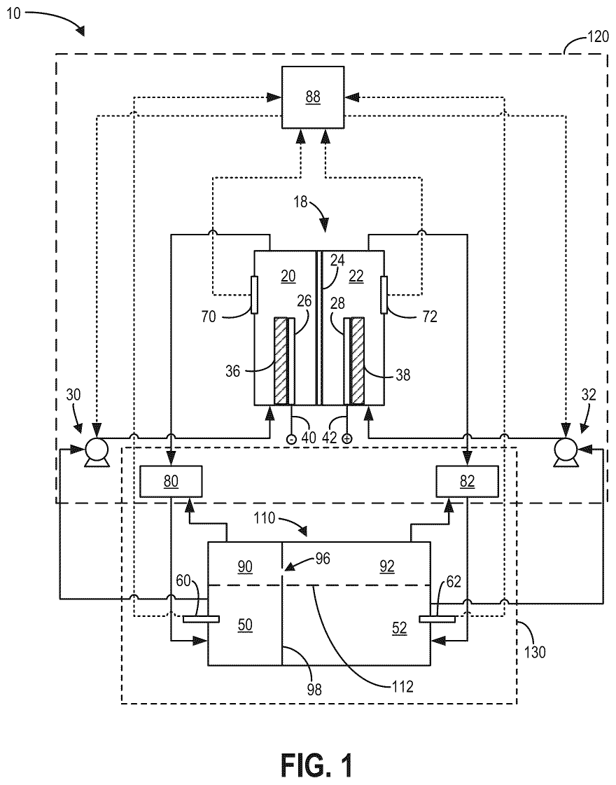

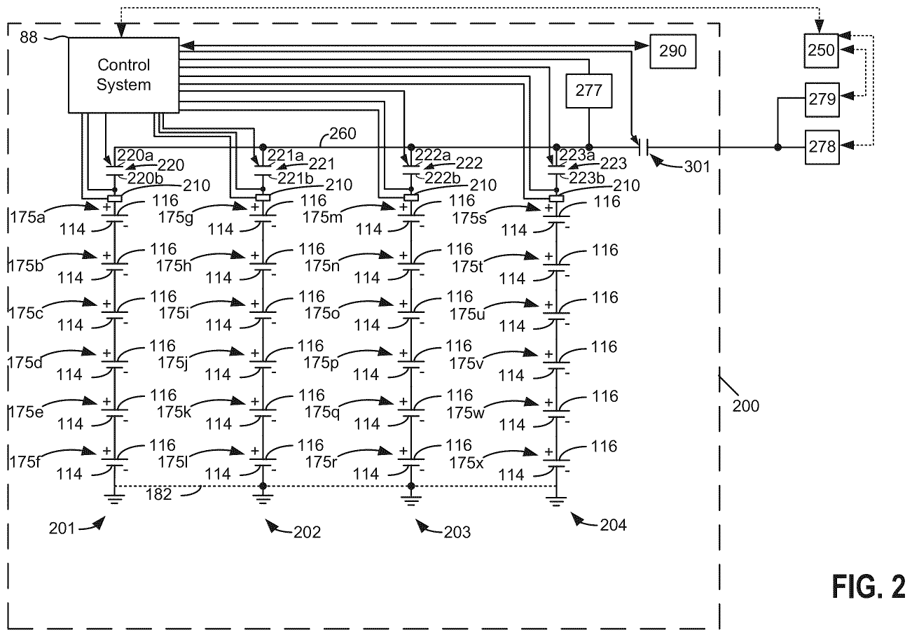

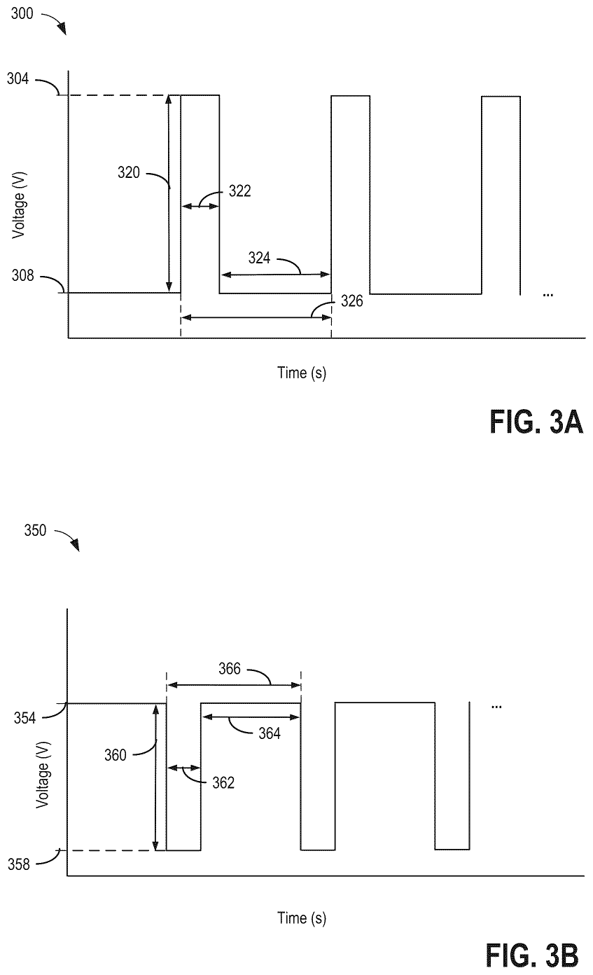

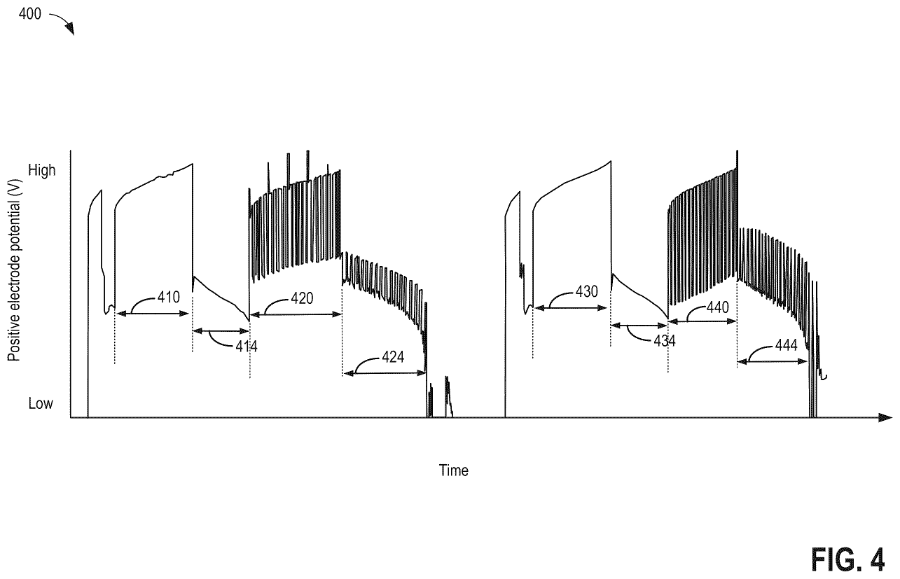

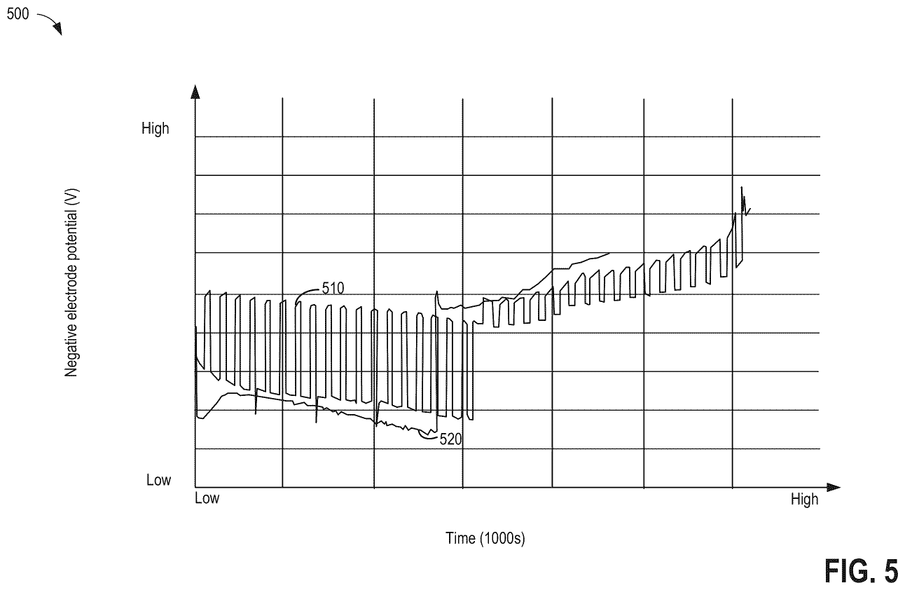

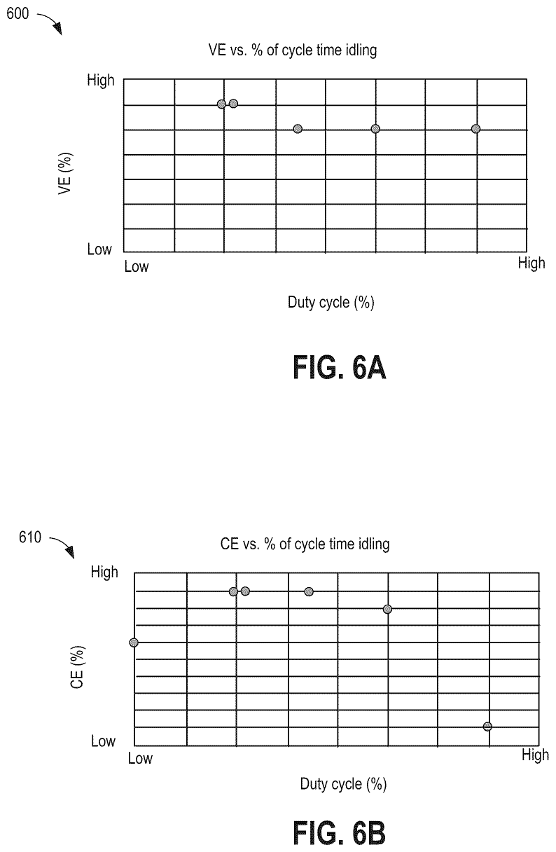

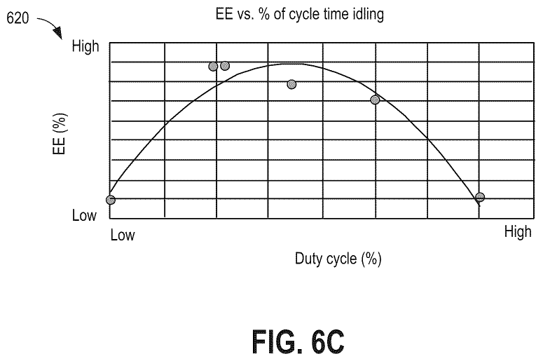

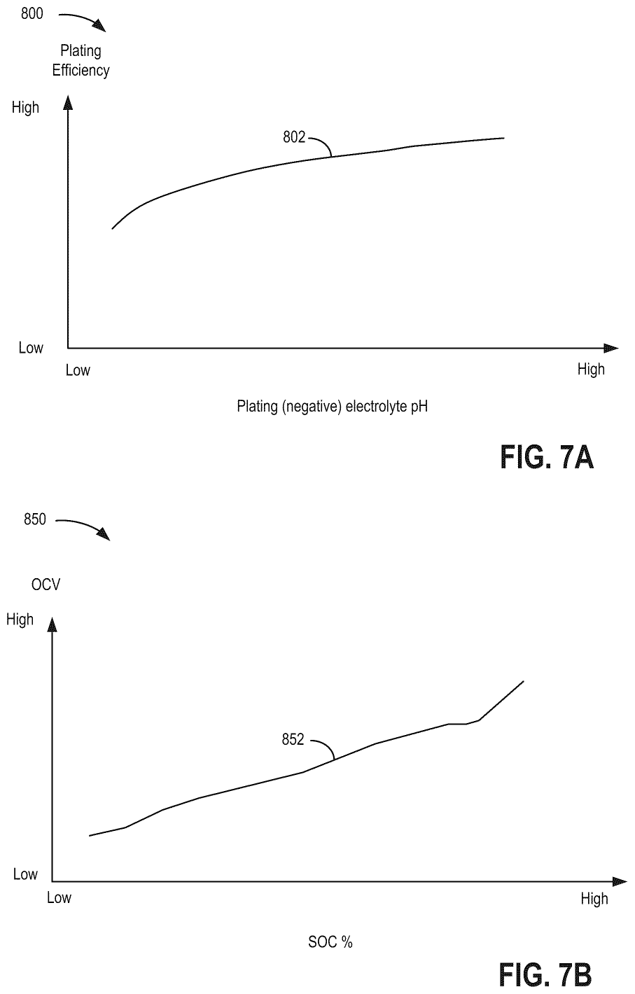

A redox flow battery system, including a power module and an electrolyte subsystem, are shown in FIG. 1. As shown in FIG. 2, the power module of the redox flow battery system may include one or more cell stacks, whereby each of the cell stacks includes a plurality of redox flow battery cells. Each of the redox flow battery cells may be continuously charged and/or continuously discharged or pulse charged and/or pulse discharged. Continuous charging includes supplying a continuous charging voltage signal to the redox flow battery from a power source, while continuous discharging includes supplying a continuous discharging voltage signal from the redox flow battery cell to a load. Pulse charging includes supplying a pulse-width-modulated (PWM) voltage signal to the redox flow battery cell from a power source, while pulse discharging includes supplying a PWM voltage signal from the redox flow battery cell to a load. An example PWM voltage signal is shown in FIGS. 3A-3B, while FIGS. 4 and 5 compare electrode potentials for continuous charging/discharging with electrode potentials for pulse charging/discharging of the redox flow battery system. Performance data arising from continuous charging/discharging relative to pulse charging/discharging is shown in FIGS. 6A, 6B and 6C. FIGS. 7A-7B illustrates the relationship between plating efficiency and plating electrolyte pH, and the relationship between open circuit voltage (OCV) and state of charge (SOC) for the redox flow battery system. These relationships may influence redox flow battery performance during charging and discharging cycles. A method of operating a redox flow battery, including charging and discharging one or more redox flow battery cells, is illustrated in FIGS. 8-10.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal)(Fe⁰ onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

| | | | |
|---|---|---|---|
| Fe²⁺ + 2e⁻ ↔ Fe⁰ | −0.44 V | (negative electrode) | (1) |
| 2Fe²⁺ ↔ 2Fe³⁺ + 2e⁻ | +0.77 V | (positive electrode) | (2) |

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe³⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

The SOC may be described as a ratio of an amount of electric charge stored in an electric energy storage device (e.g., an oxidation-reduction flow battery) to the full or total theoretical amount of electric charge that may be stored in the electric energy storage device. In one example, starting charging the redox flow battery may be responsive to the SOC decreasing below a lower threshold redox flow battery SOC, and stopping charging the redox flow battery may be responsive to the SOC increasing above an upper threshold redox flow battery SOC. In another example, the rates of charging and discharging power for the redox flow battery system may depend on the SOC. The positive electrolyte oxidation/reduction potential (ORP) may be measured to provide an indication of Fe³⁺ ions in positive electrolyte as a measure of SOC. However, negative electrode side reactions may offset the overall battery storage capacity from the positive state of charge, thereby reducing accuracy of the ORP as a measure of SOC. In another example, SOC may be determined by calculating a plating efficiency at the negative electrode; the plating efficiency is indicative of the rate of coulombic charge entering and exiting the redox flow battery, which may aid in evaluating redox flow battery SOC, as further described herein.

Voltage losses in a redox flow battery result from kinetic losses at the electrodes, ohmic losses, and mass transport losses. Ohmic losses arise from the voltage drop due to the transfer of electrons in the electric circuit and the movement of ions through the electrolyte and between the electrolyte and the electrodes. Plating and redox electrode kinetic losses depend on the electrode area, reaction exchange current, equilibrium potential, number of electrons in the reaction, and the reaction temperature. Ohmic losses depend on the ionic conductivity of the electrolyte and contact resistance of conductive parts. Ohmic losses, as well as plating and redox electrode kinetic losses, are both lower when temperature is increased because mobility of ions through the electrolyte and from the electrolyte to the electrodes, as well as conductivity through the electrodes are increased.

Efficiency of electrical energy storage devices, including redox flow batteries, may be indicated by their coulombic (or charge) efficiency (CE), voltaic efficiency (VE) and energy efficiency (EE); each a measure of how efficiently a battery may convert chemical energy to electrical energy and vice-versa. CE describes the charge efficiency by which electrons are transferred in the redox flow battery, and is the ratio of the total charge extracted from the battery to the total charge put into the battery over a specific redox flow battery charge/discharge cycle. VE represents the ratio of the average discharge voltage to the average charge voltage. Losses occur because the charging voltage is higher than the rated voltage to activate the chemical reaction within the battery. EE is the product of the CE and VE (EE=CE*VE), analogous to energy being the product of charge and voltage.

The performance losses may be expressed in equation form according to equations (3) and (4):

E_{charge}=Eₚₒₛ+E_{neg}+IR=(E^{eq}ₚₒₛ+η₊)+(E^{eq}_{neg}+₋)+IR (3)

E_{discharge}=Eₚₒₛ+E_{neg}−IR=(E^{eq}ₚₒₛ+η₊)−(E^{eq}_{neg}+η₋)−IR (4)

E^{eq}ₚₒₛ=E⁰ₚₒₛ−RT/nF*ln ([Fe³⁺]/[Fe^{2+]}) (5)

E^{eq}_{neg}=E⁰_{neg}−RT/nF*ln ([Fe²⁺]/[Fe⁰]) (6)

where E_{charge} is the charging potential, Epos is positive electrode potential, E_{neg} is the negative electrode potential and IR (ohmic loss) is equal to the product of the ohmic resistance, R, and the current I, for driving the positive electrode redox reaction. E^{eq}ₚₒₛ may be expressed as a sum of the equilibrium positive electrode potential, E^{eq}ₚₒₛ, and an additional positive electrode loss voltage η₊, due to the losses in efficiency at the positive electrode. Similarly, Eneg may be expressed as a sum of the equilibrium negative electrode potential, E^{eq}_{neg}, and an additional negative electrode loss voltage η₋, due to the losses in efficiency at the negative (plating) electrode. The equilibrium positive electrode and negative electrode potentials are given by equations (5) and (6), as written for the example of an IFB system.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, ORP, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)_{3.}

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, during charging mode, controller 88 may supply an electric current from a power source (such as external electric energy sources 279) conductively coupled to the terminals 40 and 42 to charge the redox flow battery 18. As further discussed in detail below with reference to FIGS. 2-8, charging the redox flow battery 18 may include pulse charging the redox flow battery 18, whereby a pulsed current and/or voltage signal is supplied from the power source to the redox flow battery 18. In another example, during discharging mode, controller 88 may regulate discharging of the redox flow battery 18 to supply power to an electrical load (such as external electric energy consumers 278) conductively coupled to the terminals 40 and 42. As further discussed in detail below with reference to FIGS. 2-8, discharging the redox flow battery 18 may include pulse discharging the redox flow battery 18, whereby a pulsed current and/or voltage signal is supplied from the redox flow battery 18 to the electrical load.

As another example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to increase a battery charge capacity during subsequent battery cycling (thus, the iron metal may be pre-formed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

Referring now to FIG. 2, a schematic block diagram of an electric energy storage system 200 that includes a plurality of the IFB cells 175a-175x and controller 88. In one example, the power module 120 of the redox flow battery system 10 in FIG. 1 may include the electric energy storage system 200. In this way, the redox flow battery system 10 may include one or more stacks of IFB cells (e.g., electric energy storage cell stacks 201, 202, 203, and 204 also referred to as cell stacks 201-204). Controller 88 may read voltage levels of electric energy storage cell stacks 201-204 and current flow through electric energy storage cell stacks 201-204 via sensors 210. Controller 88 may also selectively operate contactors 220-223, main contactor 301, and charger 277. Controller 88 may receive input from and provide output to human/machine interface 290, which may be a display panel, remote device, push-button panel, or other known interface. Controller 88 may communicate data (e.g., SOC values) to external controller 250 via network (e.g., local area network (LAN), controller area network (CAN), or other known network) so that external controller 250 may operate external electric energy consumers 278 and external electric energy sources 279 in conjunction with operation of electric energy storage system 200. External controller 250, as well as external electric energy consumers 278 and external electric energy sources 279 may be external to the redox flow battery system 10. Controller 88 may receive data and instructions from human/machine interface 290 (e.g., display panel, keyboard, pushbuttons, etc.). Further, controller 88 may send data to human/machine interface 290 and external controller 250.

IFB cells 175a-175x are the same as the redox flow battery cell 18 shown in FIG. 1. The letter designations are provided simply to identify individual electric energy storage cells. IFB cells 175a-175f are arranged in a first cell stack 201. IFB cells 175g-175l are arranged in a second cell stack 202. IFB cells 175m-175r are arranged in a third cell stack 203. IFB cells 175s-175x are arranged in a fourth cell stack 204. Although FIG. 2 shows four cell stacks in electric energy storage system 200, electric energy storage system 200 is not limited to four electric energy storage cell stacks. Rather, electric energy storage system 200 may include from 1 to N electric energy storage cell stacks, where N is an integer number. Further, each electric energy storage cell stack shown in FIG. 2 includes six electric energy storage cells (e.g., 175a-175f). However, electric energy storage system 200 is not limited to six electric energy storage cells in each electric energy storage cell stacks. Rather, electric energy storage system 200 may include from 1 to M electric energy storage cells in an electric energy storage cell stack, where M is an integer number. Each of electric energy storage cells 175a-175x includes a positive side 116 and a negative side 114. In some examples negative side 114 of an Mth energy storage cell of each cell stack of cell stacks 201-204 may be coupled to ground. In alternate examples, negative side 114 of an M^{th} energy storage cell of each of cell stacks 201-204 may be floating and bussed together with a neighboring cell stack as denoted by dashed lines 182.

Each electric energy storage cell stacks 201-204 includes a contactor 220-223 for selectively individually coupling and decoupling electric energy storage cell stacks 201-204 to electric power conductor or bus 260. Contactor 220 includes a first side 220a, which is directly coupled to electric power conductor 260, and a second side 220b, which is directly coupled to electric energy storage cell stack 201. Likewise, contactors 221-223 include first sides 221a, 222a, and 223a, which are directly coupled to electric power conductor 260, and second sides 221b, 222b, and 223b, which are directly coupled to electric energy storage cell stacks 202-204. Contactors 220-223 may be open (e.g., not allowing current to flow through the contactor) when electric energy storage system 200 is deactivated. Further, contactors 220-223 may be individually opened and closed (e.g., allowing current flow through the contactor) to selectively electrically isolate selected electric energy storage cell stacks 201-204 from electric power conductor 260 when one or more of electric energy storage cells 175a-175x are cleansed. Contactors 220-223 may be selectively opened and closed via controller 88.

Charger 277 may supply electrical charge to electric power conductor 260 when commanded by controller 88. Electrical power conductor 260 may distribute the electrical charge to electric energy storage cell stacks 201-204 when contactors 220-223 are closed. Further, charger 277 may supply electrical charge individually to individual electric energy storage cell stacks 201-204. For example, charger 277 may only charge electric energy storage cell stack 201 when contactor 220 is closed and contactors 221-223 are open. In another example of individually charging electric energy cell stacks, charger 277 may only charge electric energy storage cell stacks 201 and 204 when contactors 220 and 223 are closed and contactors 221 and 222 are open. Charger 277 may be selectively activated to supply charge and deactivated to cease supplying charge via controller 88. Charger 277 may also be commanded to supply charge until electric power conductor 260 and electric energy storage cell stacks that are electrically coupled to electric power conductor 260 are at charge or voltage levels as requested by controller 88.

Electric energy storage system 200 also includes a main contactor 301 that may be opened and closed via controller 88. Main contactor 301 may be closed to electrically couple electric power conductor 260 to external electric energy sources (e.g., photovoltaic cells, wind turbines, hydroelectric generators, etc.) 279 and external electrical energy consumers (e.g., house hold appliances, industrial motors, vehicle propulsion sources, etc.) 278. Main contactor 301 may be opened to electrically isolate IFB cell electric energy power conductor 260 from external electric energy sources 279 and external electric energy consumers 278. External electric energy sources 279 and external electric energy consumers 278 are external to electric energy storage system 200.

Referring now to FIG. 7A, a graph 800 that illustrates an example relationship between plating (negative) electrolyte pH and negative electrode plating efficiency for an IFB is shown. The vertical axis represents negative electrolyte plating efficiency and negative electrolyte plating efficiency increases in the direction of the vertical axis arrow. The horizontal axis represents plating electrolyte pH and plating electrolyte pH increases in the direction of the horizontal axis arrow. Curve 802 represents the relationship between plating electrolyte pH and negative electrode plating efficiency, which may be referred to as the coulombic efficiency for the negative plating reaction. In one example, the relationship between plating efficiency and pH, as represented by the curve 802, may be expressed as shown in equation (7) below.

Plate_{eff}=0.138*ln(pH)+0.8514 (7)

Plate_{eff} is the plating efficiency of the negative electrode, In is the natural logarithm, and pH is the pH value of the plating electrolyte.

In one example, the plating efficiency may be empirically determined by adjusting the pH of the plating electrolyte and determining the plating efficiency for each pH value during charging of the IFB. The plating efficiency may be determined by measuring and dividing the actual weight of metal deposited to the negative electrode during charging of the IFB by the theoretical weight of metal that would be deposited to the negative electrode during charging of the iron flow electric energy storage cell according to Faraday's law.

Referring now to FIG. 7B, a graph 850 that illustrates an example relationship between battery SOC and open circuit voltage (OCV) at is shown. In one example, the OCV represents the battery voltage measured at positive and negative bus bars of the electric energy storage system 200. The graph 850 represents a function that outputs SOC for a redox flow battery. The function may be referenced or indexed by way of the OCV (e.g., voltage of the IFB cell or cell stack when the IFB cell or cell stack is disconnected from external electric loads). The vertical axis represents plating OCV and OCV increases in the direction of the vertical axis arrow. The horizontal axis represents SOC % and SOC % increases in the direction of the horizontal axis arrow. Curve 852 represents the relationship between SOC % and OCV. In one example, the relationship between OCV and SOCocv, as represented by the curve 852, may be expressed as shown in equation (8)

SOC ocv=−0.518*OCV²⁺67.098*OCV−2010.7 (8)

SOCocv is the redox flow battery SOC determined as a function of the OCV of the redox flow battery.

In one example, the SOC and OCV relationship may be empirically determined by measuring the OCV and then fully discharging the battery while measuring the amount of charge that leaves the battery during the discharge process. The amount of charge that exits the battery during the discharge process divided by theoretical amount of charge the battery may store indicates the SOC for a particular OCV.

The SOC values for the positive and negative electrolytes may be calculated from equations (9) and (10).

$${SOC}_{p o s} = \frac{{\sum }_{i = 0}^{n} ( \frac{{I}_{tot}}{F} - \frac{{I}_{s , pos , i}}{F} - {A}_{a} {N}_{F e 3 +} ) Δ {t}_{i}}{{{V}_{p o s , 0} [ {Fe}^{2 +} ]}_{0} + {\sum }_{i = 0}^{n} [ - ( {N}_{F e 2 +} + {N}_{F e 3 +} ) {A}_{a} Δ {t}_{i} ]} \qquad ( 9 )$$

$${SOC}_{n e g} = \frac{{\sum }_{i = 0}^{n} ( \frac{{I}_{tot * η}}{2 F} - \frac{{I}_{s , neg , i}}{2 F} - \frac{1}{2} {A}_{a} {N}_{F e 3 +} ) Δ {t}_{i}}{{{V}_{n e g , 0} [ {Fe}^{2 +} ]}_{0} + {\sum }_{i = 0}^{n} [ ( {N}_{F e 2 +} + \frac{3}{2} {N}_{F e 3 +} ) {A}_{a} Δ {t}_{i} ]} \qquad ( 10 )$$

In equations (9) and (10), SOCₚₒₛ is the SOC based on the positive electrolyte, n is the number of steps in the summation during the time interval in which SOC is estimated, Iₜₒₜ is the total current flow through the electric energy cell stack during the time interval in which SOC is estimated, F is Faraday's number, I_{s,pos,i} is the total shunt current for the positive electrolyte during the time interval in which SOC is estimated, A_{α}is the iron flow battery system active area, N_{Fe3+} is the flux density for ferric ions from the positive electrolyte to the negative electrolyte, At is the time interval between steps, V_{pos,0} is the initial volume of the positive electrolyte, [Fe²⁺ ]₀ is the initial concentration of ferrous ions in the positive and negative electrolytes, N_{Fe2+} is the flux density for ferrous ions from the positive electrolyte to the negative electrolyte, SOC_{neg} is SOC based on negative electrolyte, η is the coulombic efficiency (e.g., plating efficiency, Plate_{eff}) for the negative plating reaction, I_{s,neg,i} is the total shunt current for the negative electrolyte during the time interval in which SOC is estimated, and V_{neg,0} is the initial volume of the negative electrolyte.

V_{pos,0} and V_{neg,0} may be determined by way of level sensors, such as sensors 60 and 62. Alternately, V_{pos,0} and V_{neg,0} may be characteristic of the redox flow battery system, and may be stored in non-volatile memory of onboard controller 88. Iₜₒₜ may be measured by a current sensor, which may be integrated with the controller 88 and/or an external controller 250. A_{α}refers to the active electrode area of the redox flow battery, and Δtᵢ, refers to the time interval between summation steps. [Fe²⁺] is the initial concentration of ferrous ions in the positive and negative electrolytes, which may be measured by sensors 60 and 62. N_{Fe2+} and N_{Fe3+} refer to the flux densities (change in concentration per area per time) for ferrous and ferric ions, respectively, from the positive electrolyte to the negative electrolyte, and may be determined by changes in ferrous and ferric ion electrolyte concentrations over Δtᵢ, as measured by sensors 60 and 62 and determined in relation to A_{α}. In another example, the flux densities may be determined by empirically evaluating ionic movement within the redox flow battery by ex-situ ion chromatography measurement of electrolyte ionic concentrations. The shunt currents, I_{s,pos,i} and I_{s,neg,i} may be empirically determined. In one example, the shunt current in the electric energy storage cell stack may be empirically determined by measuring battery capacity loss over idling conditions while no external current is applied, but all battery cells are connected by way of an electrolyte shunt path.

During charging, the redox flow battery SOC is given by equation 11.

SOC=max (SOCₚₒₛ, SOC_{neg}) (11)

Max is a function that returns the greater value of arguments SOCₚₒₛ and SOC_{neg}. During discharging, the redox flow battery SOC is given by equation (12).

SOC=min (SOCₚₒₛ, SOC_{neg}) (12)

Min is a function that returns the lesser value of arguments SOCₚₒₛ and SOC_{neg}. These SOC values are SOC values that are based on the positive and negative electrolyte, respectively. The SOC values, as determined from equations (9) and (10) based on the positive and negative electrolyte, may be compared with the SOC_{OCV} from equation (8) (based on measured OCV). SOC/SOC_{OCV} being less than a threshold SOC ratio may indicate degradation of the electrolyte, for example, due to side reactions or electrolyte crossover. As examples, the controller 88 may switch from charging the electric energy cell stack of a redox flow battery to discharging the electric energy cell stack of a redox flow battery when a SOC increases above an upper threshold redox flow battery SOC during charging. Similarly, the controller 88 may switch from discharging the electric energy cell stack of a redox flow battery to charging the electric energy cell stack of a redox flow battery when a SOC decreases below a lower threshold redox flow battery SOC while discharging. Alternatively, an external controller 250 may demand that the electric energy storage system of a redox flow battery to transition from discharging to charging, or vice-versa. The upper threshold redox flow battery SOC and lower threshold redox flow battery SOC may be predetermined quantities, and may correspond to when the electric energy cell stack is charged to capacity and fully discharged, respectively.

Charging and discharging an electric energy cell stack of a redox flow battery may include pulse charging and pulse discharging the electrical energy cell stack of the redox flow battery. Referring now to FIG. 3A, it illustrates an example 300 of an oscillating voltage signal supplied to a redox flow battery during charging. The oscillating voltage signal includes a pulse-width-modulated (PWM) signal that fluctuates between a pulse floor 308 and a pulse ceiling 304, with a pulse amplitude 320 given by the difference between the pulse ceiling 304 and the pulse floor 308. Each individual pulse maintains the voltage at the pulse ceiling 304 for a pulse duration 322, and is followed by an idle time 324, during which the charging voltage is reduced to the pulse floor 308. In this way, the oscillating voltage signal during charging has a characteristic pulse period 326, defined by the sum of the pulse duration 322 and the idle time 324, as given by equation (13). Furthermore, a duty cycle of the PWM signal is represented by a ratio of the pulse duration 322 to the pulse period 326, as given by equation (14), and a % Idle time is given by equation (15).

Pulse period=Pulse duration+Idle time (13)

Duty cycle (%)=100%*Pulse duration/Pulse Period (14)

% Idle time=100%*Idle time/Pulse Period=100−Duty cycle (15)

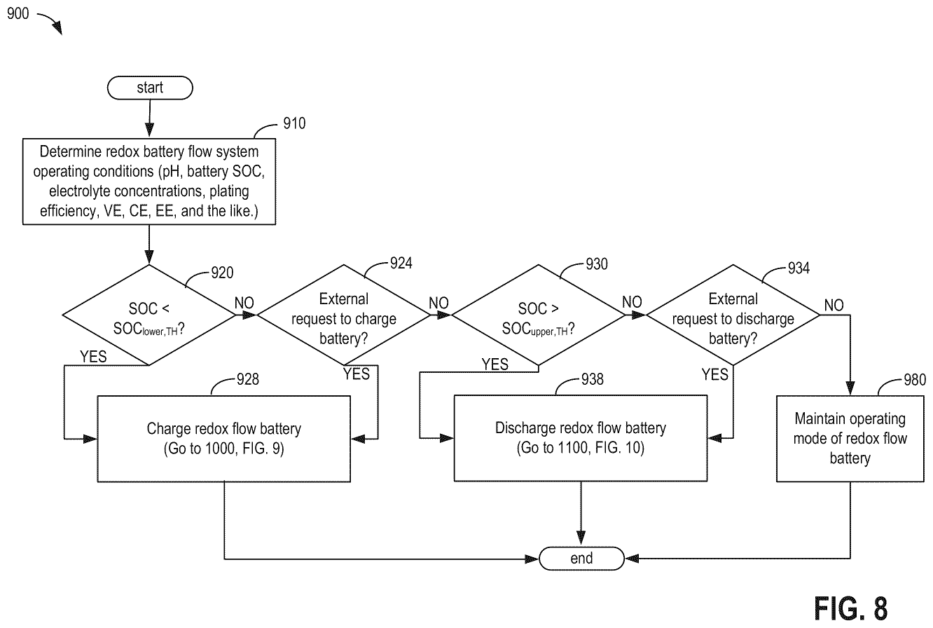

In one example, pulse charging the redox flow battery may include supplying a PWM voltage signal that fluctuates between a lower threshold charging voltage (pulse floor 308) and an upper threshold charging voltage (pulse ceiling 304), wherein the lower threshold charging voltage is less positive than the upper threshold charging voltage. In the case of a redox flow battery, the upper threshold charging voltage may correspond to a threshold charging power. As one example, the threshold charging power may include 50 kW or 60 kW. In some examples, the charging power and/or charging power density may be predetermined by the operator according to the power demand for a particular application. The threshold charging power may be achieved by supplying charging current to the redox flow battery at a threshold charging current density. In one example, the charging current density may be 45 mA/cm², expressed in units of current per active electrode area. Furthermore, the lower threshold charging voltage may correspond to the OCV of the redox flow battery. Further still, during the idle time 324 between charging pulses, the controller 88 may set the current to 0 A such that no power is supplied to the redox flow battery. Furthermore, because the redox flow battery OCV varies with SOC (as illustrated in FIG. 9), the pulse floor may change during charging of the redox flow battery. In one example, the pulse amplitude 320 of the PWM voltage signal during charging may be maintained at a predetermined value while charging; thus, both the pulse floor 308 and the pulse ceiling 304 may vary during charging of the redox flow battery in order to maintain pulse charging at the threshold charging power, as shown in FIGS. 4 and 5. As such, the charging current may be supplied to achieve the desired charging current density and pulse amplitude 320 of the PWM voltage signal. In another example, as further described with reference to FIG. 6A-6C, the duty cycle of the PWM voltage signal may be varied during charging and /or discharging in order to increase a performance characteristic (e.g., VE, CE, and or EE) of the redox flow battery system.

Referring now to FIG. 3B, it illustrates an example 350 of an oscillating voltage signal supplied to a redox flow battery during discharging. The oscillating voltage signal includes a PWM signal that fluctuates between a pulse floor 354 and a pulse ceiling 358, with a pulse amplitude 360 given by the difference between the pulse ceiling 358 and the pulse floor 354. Each individual pulse maintains the voltage at the pulse ceiling 358 for a pulse duration 362, followed by an idle time 364, during which the discharging voltage is reduced to the pulse floor 354. In this way, the oscillating voltage signal during discharging has a characteristic pulse period 366, defined by the sum of the pulse duration 362 and the idle time 364, as given by equation (13). Furthermore, a duty cycle of the PWM signal is represented by a ratio of the pulse duration 362 to the pulse period 366, as given by equation (14).

In one example, pulse discharging the redox flow battery may include supplying a PWM voltage signal that fluctuates between a lower threshold discharging voltage (pulse floor 354) and an upper threshold discharging voltage (pulse ceiling 358), wherein the lower threshold discharging voltage is less negative than the upper threshold discharging voltage. In the case of a redox flow battery, the upper threshold discharging voltage may correspond to a threshold discharging power. As one example, the threshold discharging power may include −10 kW, whereby the negative sign indicates power (e.g., current and voltage) being supplied from the redox flow battery. In some examples, the discharging power and/or discharging power density may be predetermined by the operator according to the power demand for a particular application. The threshold discharging power may be achieved by supplying discharging current from the redox flow battery at a threshold discharging current density. In one example, the discharging current density includes 45 mA/cm². Furthermore, the lower threshold discharging voltage may correspond to the OCV of the redox flow battery. Further still, during the idle time 364 between charging pulses, the controller 88 may set the current to 0 A such that no power is supplied from the redox flow battery. Further still, because the redox flow battery OCV varies with SOC, the pulse floor 354 may change during discharging of the redox flow battery. In one example, the pulse amplitude 360 of the PWM voltage signal during discharging may be maintained at a predetermined value; thus, both the pulse floor 354 and the pulse ceiling 358 may vary during discharging of the redox flow battery in order to maintain pulse discharging at the threshold discharging power, as shown in FIGS. 4 and 5. As such, the discharging current may be supplied to achieve the desired discharging current density and pulse amplitude 360 of the PWM voltage signal.

Turning now to FIG. 4, it illustrates a graph 400 comparing the positive electrode potential for a continuous charging and continuous discharging cycle of a redox flow battery and for a pulse charging and pulse discharging cycle of a redox flow battery. In the example of FIG. 4, the redox flow battery may be an IFB, however, other types of redox flow batteries may be utilized. Furthermore, other than the differences in the nature of the charge/discharge voltage signals supplied to/from the redox flow battery, the operational parameters and characteristics (e.g., electrode materials of construction and configuration, flow configuration, electrolyte flow rate and composition, electrolyte volumes, temperature, membrane type, charge/discharge current density, electrode plating preformation, electrolyte rebalancing rates, and the like) of the redox flow battery are maintained the same.

During charging (continuous and pulsed) the redox flow battery system is charged from a lower threshold redox flow battery SOC to an upper threshold redox flow battery SOC, while during discharging (continuous and pulsed) the redox flow battery system is discharged from the upper threshold redox flow battery SOC to the lower threshold redox flow battery SOC. In one example, the lower threshold redox flow battery SOC includes 20% of the maximum SOC of the redox flow battery, and the upper threshold redox flow battery SOC includes 80% of the maximum SOC of the redox flow battery. In another example, the lower threshold redox flow battery SOC includes 35% of the maximum SOC of the redox flow battery and the upper threshold redox flow battery SOC includes 65% of the maximum SOC of the redox flow battery. The increase in performance (e.g., VE, and/or EE) of the redox flow battery system for pulse charging (and/or pulse discharging) relative to continuous charging (and/or continuous discharging) may depend on the lower threshold SOC and/or the upper threshold SOC.

Furthermore, in one example, during charging, when the SOC increases above the upper threshold SOC, the redox flow battery system may be switched from pulse charging to continuous charging in order to increase plating efficiency and to reduce charging times (e.g. faster charging). Similarly, during discharging, when the SOC decreases below the lower threshold SOC, the redox flow battery system may be switched from pulse discharging to continuous discharging in order to reduce discharging times (e.g. faster discharging).

Referring to FIG. 4, in a first example, the IFB is continuously charged from the lower threshold redox flow battery SOC to the upper threshold redox flow battery SOC for a continuous charging duration 410 and then continuously discharged from the upper threshold redox flow battery SOC to the lower threshold redox flow battery SOC for a continuous discharging duration 414. Subsequently, the IFB is pulse charged from the lower threshold redox flow battery SOC for a pulse charging duration 420 and then pulse discharged from the upper threshold redox flow battery SOC to the lower threshold redox flow battery SOC for a pulse discharging duration 424. In a second example, the IFB is continuously charged from the lower threshold redox flow battery SOC to the upper threshold redox flow battery SOC for a continuous charging duration 430 and then continuously discharged from the upper threshold redox flow battery SOC to the lower threshold redox flow battery SOC for a continuous discharging duration 434. Subsequently, the IFB is pulse charged from the lower threshold redox flow battery SOC for a pulse charging duration 440 and then pulse discharged from the upper threshold redox flow battery SOC to the lower threshold redox flow battery SOC for a pulse discharging duration 444. By sequentially operating the IFB to perform a continuous charge/discharge cycle followed by a pulse charge/discharge cycle, the cycle efficiencies may be compared back-to-back, thereby reducing the influence of electrolyte crossover and other forms of system degradation that may occur over the life of the redox flow battery system. In FIG. 4, the peak and dip in the positive electrode potential just prior to the continuous charging durations 410 and 430, are artifacts of electronic switching devices during testing, and not indicative of continuous charging or continuous discharging performance. Furthermore, the outlier spikes in positive electrode potential during the pulse charging duration 420 and at the end of the pulse charging duration 440 are also artifacts of electronic switching devices during testing, and not indicative of pulse charging or pulse discharging performance.

During the continuous charging durations (410, 430) and pulse charging durations (420, 440), the positive electrode potential increases as the redox flow battery is charged and the SOC increases. Conversely, during the continuous discharging durations (414, 434) and pulse discharging durations (424, 444), the positive electrode potential decreases as the redox flow battery is discharged and the SOC decreases. During continuous charging, the charging voltage signal supplied to the IFB (e.g., the positive electrode potential) is selected to maintain the desired current density (e.g., 45 mA/cm²) and charging power (e.g., 50 or 60 kW). During pulse charging, the pulse floor is set to the OCV, and the pulse amplitude and pulse ceiling are selected to maintain the desired current density (e.g., 45mA/cm²) and charging power (e.g., 50 or 60 kW) for the predetermined duty cycle. During continuous discharging, the discharging voltage signal supplied to the IFB (e.g., the positive electrode potential) is selected to maintain the desired current density (e.g., 45 mA/cm²) and discharging power (e.g., −10 kW). During pulse discharging, the pulse floor is set to the OCV, and the pulse amplitude and pulse ceiling are selected to maintain the desired current density (e.g., 45mA/cm²) and discharging power (e.g., −10 kW) for the predetermined duty cycle. In one example, the discharging current is maintained at −0.5 A during discharging pulses. A 4 to 5% increase in VE in pulse charging/discharging cycles as compared with continuous charging cycles was obtained, with very small changes in CE. The results are based off electronic control and CE is assumed to be close to 100% CE. As such, gains in VE are reflected as well by the changes in EE between continuous and pulse charging/discharging cycles; in other words, a 4 to 5% increase in EE in pulse charging/discharging cycles as compared to continuous charging cycles was obtained. The performance gains with respect to VE and EE for pulse charge/discharge relative to continuous charge/discharge may increase as the charging power and discharging power is increased.

Turning now to FIG. 5, it illustrates a graph 500 of negative electrode potential with time for the IFB system utilized in FIG. 4 and previously described. Graph 500 compares negative electrode performance between pulse and non-pulsed tests by overlaying a plot corresponding to a pulse charging and discharging cycle 510 with a plot corresponding to a continuous charging and discharging cycle 520. The graph 500 shows that the gains in VE largely arise from reduced negative overpotentials. In a battery system, overpotential refers to the potential difference (or voltage difference) between a theoretical or thermodynamically determined voltage and the actual voltage under operating conditions. In a redox flow battery, overpotentials indicate that more energy is expended than thermodynamically determined in order to drive a redox reaction. In other words, as applied to the graph 500, during continuous charging, the negative electrode potentials are greater in magnitude (e.g. more negative) than during pulse charging, indicating lower VE since higher voltage (more energy) is supplied to the redox flow battery during continuous charging. Similarly, during pulse discharging, the pulsed negative electrode potentials are greater in magnitude (more negative) than during continuous discharging, indicating higher VE when pulse discharging since a higher voltage (more energy) may be supplied from the redox flow battery when pulse discharging relative to continuous discharging. Note, the outlier spikes in negative electrode potential during the pulse charging and at the end of the pulse charging duration are artifacts of electronic switching devices during testing, and not indicative of pulse charging or pulse discharging performance.

In contrast to the higher VE for pulse charging relative to continuous charging, plating efficiency tests for pulse charging are slightly lower than for continuous charging. The plating efficiency measured was 91%, which is slightly lower than 93% at the same system conditions without pulsing. The reduction in plating efficiency during pulse charging is most likely caused by the idle time in between pulses. Longer idle times (e.g., lower duty cycles) result in longer charging and discharging cycles. As such, the time to plate a predetermined amount of material on to the plating electrode is increased with longer idle times. The longer charging and discharging cycles for pulse charging relative to continuous charging is shown in FIG. 5; continuous charging of the redox flow battery is completed after approximately 13000 s, while pulse charging of the redox flow battery is completed after 15000 s. Furthermore, continuous discharging of the redox flow battery is completed after approximately 10000 s, while pulse charging of the redox flow battery is completed after about 15000 s.

In one example, the controller 88 may transition from pulse charging to continuous charging (and vice versa), and from pulsed discharging to continuous discharging (and vice versa), depending on the redox flow battery system operating conditions, and the external power demand. As an example, the external power demand may be transmitted to the redox flow battery system 10 from an external controller 250. As previously described, pulse charging and pulse discharging may increase efficiency of the redox flow battery system, particularly the voltage and energy efficiency. However, pulse charging and discharging cycles may be longer due to idle times, and plating efficiency may be slightly reduced relative to continuous charging and discharging. Under certain operating and/or external power demand conditions, reducing charging and discharging cycle times may also be desirable. Thus, as shown in Table 1, the controller 88 may switch from pulse charging to continuous charging responsive to the redox flow battery SOC increasing above a continuous charging threshold redox flow battery SOC (SOC_{cont,charge,TH}). The continuous charging threshold redox flow battery SOC is greater than the lower threshold redox flow battery SOC (SOC_{lower,TH}) and less than SOC_{upper,TH}. As such, responsive to the redox flow battery SOC decreasing below the lower threshold redox flow battery SOC, controller 88 may begin pulse charging the redox flow battery. Subsequently, responsive to the redox flow battery SOC increasing above the continuous charging threshold redox flow battery SOC, the controller 88 may switch from pulse charging to continuous charging the redox flow battery. Pulse charging the redox flow battery from the lower threshold redox flow battery SOC to the continuous charging threshold SOC, and continuous charging the redox flow battery above the continuous charging threshold SOC may allow for the redox flow battery system to maintain higher efficiencies (VE, CE, EE) while increasing plating efficiency, and reducing charging cycle times.

TABLE 1
Threshold SOC for pulse and continuous charge/discharge cycling

| | Type of charge/ |
|---|---|
| Redox flow battery SOC | discharge cycling |
| SOC > SOC_{upper,TH} | Pulse discharge |
| SOC_{upper,TH} > SOC > SOC_{cont,charge,TH} | Continuous charge |
| | or pulse discharge |
| SOC_{cont,charge,TH} > SOC > SOC_{cont,discharge,TH} | Pulse charge or pulse |
| | discharge |
| SOC_{cont,discharge,TH} > SOC > SOC_{lower,TH} | Pulse charge or |
| | continuous discharge |
| SOC < SOC_{lower,TH} | Pulse charge |

As another example, the controller 88 may switch from pulse discharging to continuous discharging responsive to the redox flow battery SOC decreasing below a continuous discharging threshold redox flow battery SOC (SOC_{cont,discharge,TH}). The continuous discharging threshold redox flow battery SOC is less than the upper threshold redox flow battery SOC (SOC_{upper,TH}) and greater than SOC_{lower,TH}. As such, responsive to the redox flow battery SOC increasing above the upper threshold redox flow battery SOC, controller 88 may begin pulse discharging the redox flow battery. Subsequently, responsive to the redox flow battery SOC decreasing below the continuous discharging threshold redox flow battery SOC, the controller 88 may switch from pulse discharging to continuous discharging the redox flow battery. Pulse discharging the redox flow battery from the upper threshold redox flow battery SOC to the continuous discharging threshold SOC, and continuous discharging the redox flow battery below the continuous discharging threshold SOC may allow for the redox flow battery system to maintain higher efficiencies (VE, CE, EE) while increasing plating efficiency, and reducing discharging cycle times.

Furthermore, the values of SOC_{cont,discharge,TH} and SOC_{cont,charge,TH} may be adjusted depending on a desired charge/discharge cycle time, plating efficiency, and or system efficiency (VE, EE, CE). When SOC_{cont,charge,TH} is near in value to SOC_{upper,TH}, charging the redox flow battery is virtually all pulse charging. Conversely, when SOC_{cont,charge,TH} is near in value to SOC_{lower,TH}, charging the redox flow battery is virtually all continuous charging. Furthermore, when SOC_{cont,charge,TH} is at the midpoint SOC between SOC_{lower,TH} and SOC_{upper,TH} then charging the redox flow battery includes pulse charging the redox flow battery from SOC_{lower,TH} to the midpoint SOC, and then continuously charging the redox flow battery from the midpoint SOC to SOC_{upper,TH}. In other words, charging of the redox flow battery includes half pulse charging and half continuous charging, on a SOC basis. Further still, raising SOC_{cont,charge,TH} increases an amount of pulse charging relative to continuous charging when the redox flow battery is charged from SOC_{lower,TH} to SOC_{upper,TH}; lowering SOC_{cont,charge,TH} decreases an amount of pulse charging relative to continuous charging when the redox flow battery is charged from SOC_{lower,TH} to SOC_{upper,TH}.

When SOC_{cont,discharge,TH} is near in value to SOC_{lower,TH}, discharging the redox flow battery may substantially all pulse discharging. Conversely, when SOC_{cont,discharge,TH} is near in value to SOC_{upper,TH}, discharging the redox flow battery may be substantially all continuous charging. Furthermore, when SOC_{cont,discharge,TH} is at the midpoint SOC between SOC_{lower,TH} and SOC_{upper,TH} then discharging the redox flow battery may be half pulse discharging and half continuous discharging, on a SOC basis. Further still, lowering SOC_{cont,discharge,TH} increases an amount of pulse discharging relative to continuous discharging when the redox flow battery is discharged from SOC_{upper,TH} to SOC_{lower,TH}; raising SOC_{cont,discharge,TH} decreases an amount of pulse discharging relative to continuous discharging when the redox flow battery is discharged from SOC_{upper,TH} to SOC_{lower,TH}.

In one example, SOC_{cont,charge,TH} may be decreased in order to reduce charging cycle times and increase plating efficiency, despite reducing system efficiency. Thus, SOC_{cont,charge,TH} may be decreased responsive to the charging cycle increasing above a threshold charging cycle duration and/or a plating efficiency decreasing below a threshold charging plating efficiency. On the other hand, SOC_{cont,charge,TH} may be increased in order to increase system VE, EE, and/or CE, despite increasing charging cycle times and decreasing plating efficiency. Thus, SOC_{cont,charge,TH} may be increased responsive to a system efficiency (VE and/or EE) decreasing below a threshold charging efficiency. In another example, SOC_{cont,discharge,TH} may be increased in order to reduce discharging cycle times and increase plating efficiency, despite reducing system efficiency. Thus, SOC_{cont,discharge,TH} may be increased responsive to a discharging cycle time increasing above a threshold discharging duration and/or a plating efficiency decreasing below a threshold charging plating efficiency. On the other hand, SOC_{cont,discharge,TH} may be decreased in order to increase system VE, EE, and/or CE, despite increasing charging cycle times and decreasing plating efficiency. Thus, SOC_{cont,discharge,TH} may be decreased responsive to a system efficiency (VE and/or EE) decreasing below a threshold discharging efficiency.

In a further example, the controller 88 may coordinate pulse charging/discharging and continuous charging/discharging across a plurality of redox flow batteries in an electric energy storage cell stack, and/or across a plurality of electric energy storage cell stacks (e.g., one or more of electric energy storage cell stacks 201, 202, 203, 204). Thus, during operation of the redox flow battery system 10, one or more redox flow batteries may be pulse charging while one or more other redox flow batteries may be continuous charging; similarly, during operation of the redox flow battery system 10, one or more redox flow batteries may be pulse discharging while one or more other redox flow batteries may be continuous discharging. Furthermore, during operation of the redox flow battery system 10, the controller 88 may pulse charge and/or pulse discharge the redox flow batteries in one or more electric energy storage cell stacks while continuous charging and/or continuous discharging the redox flow batteries in one or more other electric energy storage cell stacks. Further still, each of the redox flow batteries in the redox flow battery system 10 may be both pulse charged and continuous charged at any given time, depending on the operating conditions and external power demand.

In another example, the controller 88 may only pulse charge/discharge the redox flow batteries of one or more electric energy storage cell stacks in a redox flow battery system while only continuous charging/discharging the redox flow batteries of one or more other electric energy storage cell stacks in a redox flow battery system. In this way, one or more of the redox flow batteries may be dedicated to pulse charging/discharging while the other redox flow batteries may be dedicated to continuous charging /discharging. Pulse charging/discharging one or more redox flow batteries while continuous charging/discharging one or more other redox flow batteries in a redox flow battery system may advantageously allow for the redox flow battery system to maintain high system efficiency (VE, CE, EE) in the redox flow batteries that are pulse charged/discharged, while maintaining faster charging/discharging cycle times for supplying power on-demand in the continuously charged/discharged redox flow batteries. In one example, responsive to a redox flow battery efficiency (VE, CE, and/or EE) decreasing below a threshold efficiency, the controller 88 may switch the redox flow battery to only continuous charging/discharging, until the redox flow battery efficiency increases above the threshold efficiency. In another example, the controller 88 may switch the redox flow battery from pulse charging/discharging to only continuous charging/discharging, responsive to the SOC ratio (SOC/SOCocv) decreasing below the threshold SOC ratio. Furthermore, responsive to switching one or more redox flow batteries from pulse charging/discharging to continuous charging/discharging, the controller 88 may switch one or more redox flow batteries from continuous charging/discharging to pulse charging/discharging operation. In particular, the controller 88 may only select the one or more redox flow batteries yielding a battery efficiency (VE, CE, and/or EE) greater than the threshold efficiency for switching from continuous charging/discharging to pulse charging/discharging operation. In this way, redox flow battery system efficiency and faster charging/discharging cycle times may be maintained.

Turning now to FIGS. 6A-6C, graphs 600, 610, and 620 representing VE, CE, and EE data, respectively, versus duty cycle, collected from a range of pulse and continuous charging/discharging tests performed with an IFB system are shown. As shown in graph 600, the VE is higher for pulse charging/discharging operation as compared with continuous charging/discharging operation (e.g., duty cycle=0). In contrast, as shown in graph 610, CE was higher during pulse charging/discharging operation corresponding to duty cycle between 10 to 15%. The CE was lower for continuous charging/discharging (duty cycle=0), and for pulse charging/discharging operation corresponding to duty cycle greater than 25%. Consequently, the EE, as shown in graph 620, also was highest for pulse charging/discharging operation corresponding to a duty cycle between 10 to 15%, and decreased at lower duty cycles (e.g., continuous charging/discharging, duty cycle=0) and higher duty cycles (greater than 25%).

Additional IFB performance data for pulse charging/discharging relative to baseline (continuous charging/discharging) operation is summarized in Tables 2 and 3. Two sets of experiments were performed with the first set charging and discharging at 60 kW (Table 2) and the second set charging and discharging at 50 kW (Table 3). The IFB was cycled between 35% SOC and 80% SOC. In other words, charging of the redox flow battery system was initiated responsive to the SOC decreasing below a lower threshold redox flow battery SOC of 35%, and discharging of the redox flow battery system was initiated responsive to the SOC increasing above an upper threshold redox flow battery SOC of 80%. For 60 kW cycles, pulse charging was implemented with a 60 kW charging power and pulse duration of 1 min. During pulse charging, a pulsed voltage signal was supplied to the redox flow battery system that oscillated between a pulse ceiling voltage (e.g., corresponding to 60 kW) and a pulse floor voltage (OCV). While pulse charging, the idle time was 9 min, yielding a charging duty cycle of 10%. Pulse discharging was implemented with a −10 kW discharging power with a pulse duration of 1 min. During pulse discharging, a pulsed voltage signal was supplied from the redox flow battery system that oscillated between a pulse ceiling voltage (e.g., corresponding to −10 kW) and a pulse floor voltage (OCV). While pulse discharging, the idle time was 9 min, yielding a discharging duty cycle of 10%. These pulse charging/discharging conditions yielded a 4% increase in VE and a 3% increase in EE, while CE was approximately maintained (−1% change) relative to baseline (continuous, 60 kW) charging and discharging conditions, as shown in Table 2. Due to the increase in VE, the redox flow battery capacity at 60 kW increased by 18% (e.g. 118% of baseline capacity) with pulse charging/discharging relative to baseline operation (continuous charging/discharging).

TABLE 2
60 kW pulse charging/discharging vs. baseline performance

| | | | | *Capacity @ |
|---|---|---|---|---|
| | CE | VE | EE | 60 kW |
| % Change from | −1 | 4 | 3 | 118 |
| baseline | | | | |

*percentage of baseline capacity

TABLE 3
50 kW pulse charging/discharging vs. baseline performance

| % Change from | | | | *Capacity @ |
|---|---|---|---|---|
| baseline | CE | VE | EE | rated power |
| Pulse (1 min) | 5 | 3 | 6 | 127 |
| Pulse (10 s) | 1 | 3 | 3 | 157 |

*percentage of baseline capacity

For 50 kW cycles, pulse charging was implemented with a 50 kW charging power and pulse duration of 1 min or 10 s. During pulse charging, a pulsed voltage signal was supplied to the redox flow battery system that oscillated between a pulse ceiling voltage (e.g., corresponding to 60 kW) and a pulse floor voltage (OCV). While pulse charging with a pulse duration of 1 min, an idle time of 9 min yielded a charging duty cycle of 10%; however, while pulse charging with a pulse duration of 10 s, the idle time between pulses was 1 s, yielding a charging duty cycle of 1.8% . Pulse discharging was implemented with a −10kW discharging power with a pulse duration of 9 min. During pulse discharging, a pulsed voltage signal was supplied from the redox flow battery system that oscillated between a pulse ceiling voltage (e.g., corresponding to −10 kW) and a pulse floor voltage (OCV). While pulse discharging, the idle time was 1 min, yielding a discharging duty cycle of 10%. Pulse charging/discharging with a pulse duration of lOs yielded a 3% increase in VE and a 3% increase in EE, while CE was approximately maintained (1% increase) relative to baseline (continuous, 50 kW) charging and discharging conditions, as shown in Table 3. Similarly, pulse charging/discharging with a pulse duration of 1 minute yielded a 3% increase in VE, a 6% increase in EE, and a 5% increase in CE relative to baseline (continuous, 50 kW) charging and discharging conditions. Furthermore, due to the increase in CE and VE the overall redox flow battery capacity at 50 kW increased 27% (e.g., 127% of baseline capacity) for 1 min idle and 57% (e.g., 157% of baseline capacity) for lOs idle relative to baseline operation, as shown in Table 3.

Turning now to FIGS. 8-10, they illustrate flowcharts for methods 900, 1000, and 1100 of operating a redox flow battery system, such as the redox flow battery cell system 10 of FIG. 1, including pulse charging and pulse discharging one or more redox flow batteries. The one or more redox flow batteries may be within a single cell stack, or may be positioned across more than one cell stack. Instructions for carrying out methods 900, 1000, and 1100 may be executed by a controller, for example, the controller 88 of FIGS. 1 and 2, based on executable instructions stored in non-transitory memory of the controller 88 and in conjunction with signals received from sensors of the redox flow battery cell system 10, such as the sensors described above with reference to FIGS. 1 and 2. The controller 88 may employ actuators of the redox flow battery system 10 to adjust operation of the redox flow battery system 10, including the power module 120 and electric energy storage system 200, and electrolyte subsystem 130, according to the methods described below.

At 910, method 900 shown in FIG. 8 includes determining redox flow battery system operating conditions, including electrolyte pH, SOC (e.g., redox flow battery SOC), electrolyte concentrations, plating efficiency, VE, CE, EE, and the like. Next, At 920, method 900 includes determining if the redox flow battery SOC is less than a lower threshold redox flow battery SOC, SOC_{lower,TH}. Responsive to SOC not being less than SOC_{lower,TH}, method 900 continues at 924, and includes determining if an external request to charge the battery has been received. Receiving an external request to charge the redox flow battery may include receiving a signal from an external device such as the external controller 250 of FIG. 2, communicatively coupled to the controller 88 of the redox flow battery system 10. In one example, the external controller 250 may monitor power supplied to a plurality of external electric energy consumers 278, and/or external electric energy sources 279, and may send a signal to charge one or more of the redox flow batteries, in response to anticipating an increase in power demand from the external electric energy consumers 278, or in response to a stored energy level of the external electric energy sources 279 decreasing below a threshold energy level. In another example, the external request to charge the redox flow battery 10 may include receiving a user input by way of the human/machine interface 290 of FIG. 2 to charge the redox flow battery 10.

Responsive to SOC<SOC_{lower,TH} at 920 or responsive to receiving an external request to charge the redox flow battery at 924, method 900 continues at 928 and includes initiating charging of the redox flow battery.

Turning now to FIG. 9, it illustrates a method 1000 for charging one or more redox flow batteries. Charging of the redox flow batteries may include one or more of pulse charging and continuous charging. In particular, method 1000 may operate the redox flow battery in a pulse charging mode or a continuous charging mode depending on battery operating conditions.

Method 1000 begins at 1020 and includes determining if the SOC<SOC_{lower,TH}. Responsive to SOC<SOC_{lower,TH}, method 1000 continues at 1024 and includes pulse charging the redox flow battery. Pulse charging the redox flow battery may include stopping the continuous charging of the redox flow battery. Returning to 1020, for the case where SOC is not less than SOC_{lower,TH}, method 1000 continues to 1040 and includes determining if SOC<SOC_{cont,charge,TH}. Responsive to SOC<SOC_{cont,charge,TH}, method 1000 continues at 1044 and includes pulse charging the redox flow battery. Pulse charging the redox flow battery may include stopping the continuous charging of the redox flow battery. Returning to 1040, for the case where SOC is not less than SOC_{cont,charge,TH}, method 1000 continues to 1060 and includes determining if SOC<SOC_{upper,TH}. Responsive to SOC<SOC_{upper,TH}, method 1000 continues at 1064 and includes continuously charging the redox flow battery. Continuously charging the redox flow battery may include stopping the pulse charging of the redox flow battery. In this way, according to method 1000 the controller 88 may operate the redox flow battery in a pulse charging mode or a continuous charging mode based on the SOC of the redox flow battery. When SOC_{cont,charge,TH}<SOC<SOC_{upper,TH}, the redox flow battery is continuously charged, and when SOC<SOC_{cont,charge,TH} or when SOC<SOC_{lower,TH}, the redox flow battery is pulse charged.

In this way, both the efficiency (VE, CE, and EE), the charging cycle time and plating efficiency of the redox flow battery may be maintained. Furthermore, the controller 88 may adjust the value of SOC_{cont,charge,TH} depending on the desired efficiency, charging cycle time, and plating efficiency. Controller 88 may reduce SOC_{cont,charge,TH} to increase a tendency for continuous charging relative to pulse charging, and thereby reduce charging cycle time and increase plating efficiency, despite reducing VE, CE, and/or EE. As one example, SOC_{cont,charge,TH} may be decreased in response to a plating efficiency of the redox flow battery decreasing below a threshold plating efficiency. Conversely, controller 88 may increase SOC_{cont,charge,TH} to decrease a tendency for continuous charging relative to pulse charging, and thereby increase efficiency (VE, CE, and, EE), despite increasing charging cycle time, and reducing plating efficiency. As one example, SOC_{cont,charge,TH} may be increased in response to a voltaic efficiency of the redox flow battery decreasing below a threshold voltaic efficiency. Returning to method 1000 after 1024, 1044, and 1064, and after 1060 for the case where SOC is not less than SOC_{upper,TH}, method 1000 returns to method 900 after 928. After 928, method 900 ends.

Returning to method 900 at 924 for the case where there is not the external request to charge the battery, method 900 continues at 930 and includes determining if the redox flow battery SOC is greater than an upper threshold redox flow battery SOC, SOC_{upper,TH}. Responsive to SOC not being greater than SOC_{upper,TH}, method 900 continues at 934, and includes determining if an external request to discharge the battery has been received. Receiving an external request to discharge the redox flow battery may include receiving a signal from an external device such as the external controller 250 communicatively coupled to the controller 88 of the redox flow battery system 10. In one example, the external controller 250 may monitor power supplied to a plurality of external electric energy consumers 278, and/or external electric energy sources 279, and may send a signal to discharge one or more of the redox flow batteries, in response to an increase in power demand from the external electric energy consumers 278, or in response to a stored energy level of the external electric energy sources 279 decreasing below a threshold energy level. In another example, the external request to discharge the redox flow battery 10 may include receiving a user input by way of the human/machine interface 290 to discharge the redox flow battery 10.

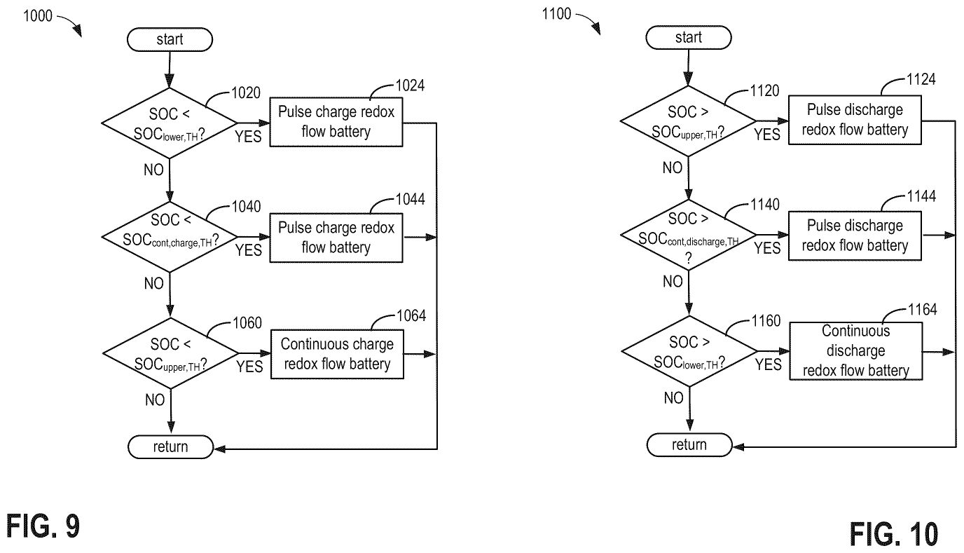

Responsive to SOC>SOC_{upper,TH} at 930 or responsive to receiving the external request to discharge the redox flow battery at 934, method 900 continues at 938 and includes initiating discharging of the redox flow battery. Turning now to FIG. 10, it illustrates a method 1100 for discharging one or more redox flow batteries. Discharging of the redox flow batteries may include one or more of pulse discharging and continuous discharging. In particular, method 1100 may operate the redox flow battery in a pulse discharging mode or a continuous discharging mode depending on battery operating conditions.

Method 1100 begins at 1120 and includes determining if the SOC>SOC_{upper,TH}. Responsive to SOC>SOC_{upper,TH}, method 1100 continues at 1124 pulse discharging the redox flow battery. Pulse discharging the redox flow battery may include stopping the continuous discharging of the redox flow battery. Returning to 1120, for the case where SOC is not greater than SOC_{upper,TH}, method 1100 continues to 1140 and includes determining if SOC>SOC_{cont,discharge,TH}. Responsive to SOC>SOC_{cont,discharge,TH}, method 1100 continues at 1144 where and includes pulse discharging the redox flow battery. Pulse discharging the redox flow battery may include stopping the continuous discharging of the redox flow battery. Returning to 1140, for the case where SOC is not greater than SOC_{cont,discharge,TH}, method 1100 continues to 1160 where and includes determining if SOC>SOC_{lower,TH}. Responsive to SOC>SOC_{lower,TH}, method 1100 continues at 1164 and includes continuously discharging the redox flow battery. Continuous discharging the redox flow battery may include stopping the pulse discharging of the redox flow battery.

In this way, according to method 1100 the controller 88 may operate the redox flow battery in a pulse discharging mode or a discontinuous charging mode based on the SOC of the redox flow battery. When SOC_{cont,discharge,TH}>SOC>SOC_{lower,TH}, the redox flow battery is continuously charged, and when SOC>SOC_{cont,discharge,TH} or when SOC>SOC_{upper,TH}, the redox flow battery is pulse charged. SOC_{cont,discharge,TH} may be adjusted in response to performance characteristics of the redox flow battery such as; voltaic efficiency, coulombic efficiency, energy efficiency, plating efficiency, and the like. As one example, SOC_{cont,discharge,TH} may be increased in response to the plating efficiency of the redox flow battery decreasing below a threshold plating efficiency. As a further example, SOC_{cont,discharge,TH} may be decreased in response to a voltaic efficiency decreasing below a threshold voltaic efficiency.

The technical effect of methods 900, 1000, and 1100 is increasing a voltaic efficiency and energy efficiency of the redox flow battery system may be achieved, while maintaining a coulombic efficiency of the redox flow battery system. In this way, efficiency of the redox flow battery may be increased without demanding additional hardware or retrofitting. Furthermore, the increases in voltaic efficiency and energy efficiency are attained while maintaining a redox flow system operating temperature, thereby lowering material costs and maintaining reliability and durability of the system plumbing. Further still, increases in voltaic efficiency and energy efficiency are attained while maintaining a plating gap at the plating electrode, thereby facilitating retrofitting of existing redox flow battery systems to achieve the gains in voltaic and energy efficiency without increasing manufacturing costs and complexity.

In this way, both the efficiency (VE, CE, and EE) and the discharging cycle time and plating efficiency of the redox flow battery may be maintained. Furthermore, the controller 88 may adjust the value of SOC_{cont,discharge,TH} depending on the desired efficiency, charging cycle time, and plating efficiency. For example, controller 88 may increase SOC_{cont,discharge,TH} to increase a tendency for continuous discharging relative to pulse discharging, and thereby reduce charging cycle time and increase plating efficiency, despite reducing VE, CE, and/or EE. Conversely, controller 88 may decrease SOC_{cont,discharge,TH} to decrease a tendency for continuous discharging relative to pulse discharging, and thereby increase efficiency (VE, CE,and, EE), despite increasing charging cycle time, and reducing plating efficiency.

Returning to method 1100 after 1124, 1144, and 1164, and after 1160 for the case where SOC is not greater than SOC_{lower,TH}, method 1100 returns to method 900 after 938. After 928, method 900 ends. Returning to method 900 at 934 for the case where there is not the external request to discharge the battery, method 900 continues at 980 and includes maintaining the current operating mode (e.g., pulse charging, pulse discharging, continuous charging, continuous discharging, or the like) of the redox flow battery. After 980, method 900 ends.

The disclosure provides support for a method of operating a redox flow battery comprising: charging the redox flow battery, including supplying a pulse charging signal to the redox flow battery in response to a redox flow battery state of charge (SOC) decreasing below a lower threshold redox flow battery SOC, wherein supplying the pulse charging signal includes supplying a pulse-width-modulated (PWM) charging voltage signal to the redox flow battery, the PWM charging voltage signal fluctuating between an upper threshold charging voltage and an open circuit voltage (OCV). In a first example of the method, the method further comprises:, discharging the redox flow battery, including supplying a pulsed discharging signal from the redox flow battery, wherein supplying the pulsed discharging signal includes supplying a PWM discharging voltage signal from the redox flow battery, the PWM discharging voltage signal fluctuating between an upper threshold discharging voltage and the OCV. In a second example of the method, optionally including the first example, the upper threshold charging voltage changes with the redox flow battery SOC, and wherein charging the redox flow battery further includes adjusting a charging current to maintain the pulse charging signal at a threshold charging power while the PWM charging voltage signal is at the upper threshold charging voltage. In a third example of the method, optionally including one or both of the first and second examples, the upper threshold discharging voltage changes with the redox flow battery SOC, and wherein discharging the redox flow battery further includes adjusting a discharging current to maintain the pulsed discharging signal at a threshold discharging power while the PWM discharging voltage signal is at the upper threshold discharging voltage. In a fourth example of the method, optionally including one or more or each of the first through third examples, the PWM charging voltage signal and the PWM discharging each include a duty cycle between a lower threshold charging duty cycle and an upper threshold charging duty cycle.

The disclosure also provides support for a redox flow battery system, comprising: a power module, including a redox flow battery, an electrolyte subsystem fluidly coupled to the redox flow battery, and a controller, including executable instructions stored in non-transitory memory thereon to: charge the redox flow battery, including to pulse charge the redox flow battery in response to a redox flow battery state of charge (SOC) decreasing below a lower threshold redox flow battery SOC, wherein to pulse charge includes to supply a pulse-width-modulated (PWM) charging voltage signal to the redox flow battery, the PWM charging voltage signal fluctuating between an upper threshold charging voltage and an open circuit voltage (OCV). In a first example of the system, the executable instructions further include to discharge the redox flow battery, including to pulse discharge the redox flow battery responsive to the redox flow battery SOC being greater than an upper threshold redox flow battery SOC while an electrical load is coupled to the redox flow battery, wherein to pulse discharge includes to supply a PWM discharging voltage signal from the redox flow battery, the PWM discharging voltage signal fluctuating between an upper threshold discharging voltage and the OCV. In a second example of the system, optionally including the first example, instructions to charge the redox flow battery further include to supply a continuous charging voltage signal to the redox flow battery in response to the redox flow battery SOC increasing above a continuous charging threshold redox flow battery SOC, the continuous charging threshold redox flow battery SOC greater than the lower threshold redox flow battery SOC. In a third example of the system, optionally including one or both of the first and second examples, the power module includes a plurality of redox flow battery cell stacks, each redox flow battery cell stack including one or more redox flow battery, and the executable instructions further include to supply the PWM charging voltage signal or the continuous charging voltage signal to charge a first of the plurality of redox flow battery cell stacks, while supplying the PWM charging voltage signal or the continuous charging voltage signal to charge a second of the plurality of redox flow battery cell stacks. In a fourth example of the system, optionally including one or more or each of the first through third examples, instructions to discharge the redox flow battery further include to supply a continuous discharging voltage signal from the redox flow battery in response to the redox flow battery SOC decreasing below a continuous discharging threshold redox flow battery SOC, the continuous discharging threshold redox flow battery SOC less than the upper threshold redox flow battery SOC. In a fifth example of the system, optionally including one or more or each of the first through fourth examples, the executable instructions further include to increase the continuous discharging threshold redox flow battery SOC responsive to a plating efficiency of the redox flow battery decreasing below a threshold plating efficiency and to lower the continuous discharging threshold redox flow battery SOC responsive to a voltaic efficiency of the redox flow battery decreasing below a threshold voltaic efficiency. In a sixth example of the system, optionally including one or more or each of the first through fifth examples, the executable instructions further include to reduce the continuous charging threshold redox flow battery SOC responsive to a plating efficiency of the redox flow battery decreasing below a threshold plating efficiency and to increase the continuous charging threshold redox flow battery SOC responsive to a voltaic efficiency of the redox flow battery decreasing below a threshold voltaic efficiency.

The disclosure also provides support for a method of operating a redox flow battery comprising: in response to a redox flow battery SOC decreasing below a lower threshold redox flow battery SOC, pulse charging the redox flow battery, and in response to the redox flow battery SOC increasing above an upper threshold redox flow battery SOC, pulse discharging the redox flow battery. In a first example of the method, pulse charging the redox flow battery includes supplying a pulse charging power signal to charge the redox flow battery, and oscillating the pulse charging power signal between a lower threshold charging power and an upper threshold charging power. In a second example of the method, optionally including the first example, the lower threshold charging power is equal to an open circuit voltage of the redox flow battery. In a third example of the method, optionally including one or both of the first and second examples, the upper threshold charging power is 50 kW and the upper threshold discharging power is −10 kW. In a fourth example of the method, optionally including one or more or each of the first through third examples, pulse charging the redox flow battery includes pulse charging with a pulse-width-modulated (PWM) power signal, the PWM power signal having a duty cycle between a lower threshold duty cycle and an upper threshold duty cycle. In a fifth example of the method, optionally including one or more or each of the first through fourth examples, pulse discharging the redox flow battery includes supplying a pulse discharging power signal to discharge the redox flow battery, and oscillating the pulse discharging power signal between a lower threshold discharging power and an upper threshold discharging power. In a sixth example of the method, optionally including one or more or each of the first through fifth examples, pulse charging the redox flow battery includes pulse charging the redox flow battery above a threshold charging current density. In a seventh example of the method, optionally including one or more or each of the first through sixth examples, pulse charging the redox flow battery includes pulse discharging the redox flow battery below a threshold discharging current density.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of operating a redox flow battery, comprising:
charging the redox flow battery, including supplying a pulse charging signal to the redox flow battery in response to a redox flow battery state of charge (SOC) decreasing below a lower threshold redox flow battery SOC, wherein supplying the pulse charging signal includes supplying a pulse-width-modulated (PWM) charging voltage signal to the redox flow battery, the PWM charging voltage signal fluctuating between an upper threshold charging voltage and an open circuit voltage (OCV).

2. The method of claim 1, further comprising, discharging the redox flow battery, including supplying a pulsed discharging signal from the redox flow battery, wherein supplying the pulsed discharging signal includes supplying a PWM discharging voltage signal from the redox flow battery, the PWM discharging voltage signal fluctuating between an upper threshold discharging voltage and the OCV.

3. The method of claim 2, wherein the upper threshold charging voltage changes with the redox flow battery SOC, and wherein charging the redox flow battery further includes adjusting a charging current to maintain the pulse charging signal at a threshold charging power while the PWM charging voltage signal is at the upper threshold charging voltage.

4. The method of claim 3, wherein the upper threshold discharging voltage changes with the redox flow battery SOC, and wherein discharging the redox flow battery further includes adjusting a discharging current to maintain the pulsed discharging signal at a threshold discharging power while the PWM discharging voltage signal is at the upper threshold discharging voltage.

5. The method of claim 2, wherein the PWM charging voltage signal and the PWM discharging each include a duty cycle between a lower threshold charging duty cycle and an upper threshold charging duty cycle.

6. A redox flow battery system, comprising:
a power module, including a redox flow battery,
an electrolyte subsystem fluidly coupled to the redox flow battery, and
a controller, including executable instructions stored in non-transitory memory thereon to:
charge the redox flow battery, including to pulse charge the redox flow battery in response to a redox flow battery state of charge (SOC) decreasing below a lower threshold redox flow battery SOC, wherein to pulse charge includes to supply a pulse-width-modulated (PWM) charging voltage signal to the redox flow battery, the PWM charging voltage signal fluctuating between an upper threshold charging voltage and an open circuit voltage (OCV).

7. The redox flow battery system of claim 6, wherein the executable instructions further include to discharge the redox flow battery, including to pulse discharge the redox flow battery responsive to the redox flow battery SOC being greater than an upper threshold redox flow battery SOC while an electrical load is coupled to the redox flow battery, wherein to pulse discharge includes to supply a PWM discharging voltage signal from the redox flow battery, the PWM discharging voltage signal fluctuating between an upper threshold discharging voltage and the OCV.

8. The redox flow battery system of claim 7, wherein instructions to charge the redox flow battery further include to supply a continuous charging voltage signal to the redox flow battery in response to the redox flow battery SOC increasing above a continuous charging threshold redox flow battery SOC, the continuous charging threshold redox flow battery SOC greater than the lower threshold redox flow battery SOC.

9. The redox flow battery system of claim 8, wherein the power module includes a plurality of redox flow battery cell stacks, each redox flow battery cell stack including one or more redox flow battery, and the executable instructions further include to supply the PWM charging voltage signal or the continuous charging voltage signal to charge a first of the plurality of redox flow battery cell stacks, while supplying the PWM charging voltage signal or the continuous charging voltage signal to charge a second of the plurality of redox flow battery cell stacks.

10. The redox flow battery system of claim 8, wherein instructions to discharge the redox flow battery further include to supply a continuous discharging voltage signal from the redox flow battery in response to the redox flow battery SOC decreasing below a continuous discharging threshold redox flow battery SOC, the continuous discharging threshold redox flow battery SOC less than the upper threshold redox flow battery SOC.

11. The redox flow battery system of claim 10, wherein the executable instructions further include to increase the continuous discharging threshold redox flow battery SOC responsive to a plating efficiency of the redox flow battery decreasing below a threshold plating efficiency and to lower the continuous discharging threshold redox flow battery SOC responsive to a voltaic efficiency of the redox flow battery decreasing below a threshold voltaic efficiency.

12. The redox flow battery system of claim 10, wherein the executable instructions further include to reduce the continuous charging threshold redox flow battery SOC responsive to a plating efficiency of the redox flow battery decreasing below a threshold plating efficiency and to increase the continuous charging threshold redox flow battery SOC responsive to a voltaic efficiency of the redox flow battery decreasing below a threshold voltaic efficiency.

13. A method of operating a redox flow battery, comprising:
in response to a redox flow battery SOC decreasing below a lower threshold redox flow battery SOC, pulse charging the redox flow battery, and
in response to the redox flow battery SOC increasing above an upper threshold redox flow battery SOC, pulse discharging the redox flow battery.

14. The method of claim 13, wherein pulse charging the redox flow battery includes supplying a pulse charging power signal to charge the redox flow battery, and oscillating the pulse charging power signal between a lower threshold charging power and an upper threshold charging power.

15. The method of claim 14, wherein the lower threshold charging power is equal to an open circuit voltage of the redox flow battery.

16. The method of claim 14, wherein the upper threshold charging power is 50 kW and the upper threshold discharging power is −10 kW.

17. The method of claim 14, wherein pulse charging the redox flow battery includes pulse charging with a pulse-width-modulated (PWM) power signal, the PWM power signal having a duty cycle between a lower threshold duty cycle and an upper threshold duty cycle.

18. The method of claim 13, wherein pulse discharging the redox flow battery includes supplying a pulse discharging power signal to discharge the redox flow battery, and oscillating the pulse discharging power signal between a lower threshold discharging power and an upper threshold discharging power.

19. The method of claim 13, wherein pulse charging the redox flow battery includes pulse charging the redox flow battery above a threshold charging current density.

20. The method of claim 13, wherein pulse charging the redox flow battery includes pulse discharging the redox flow battery below a threshold discharging current density.
